(19) United States
(12) Patent Application Publication
(10) Pub. No.: US 2013/0029046 A1
(43) Pub. Date: Jan. 31, 2013

(54) PRINTING INK CONTAINING A DIVINYL ESTER

(71) Applicants: Yvonne Heischkel, Ludwigshafen (DE); Matthias Fies, Landau (DE); Wolfgang Staffel, Otterstadt (DE)

(72) Inventors: Yvonne Heischkel, Ludwigshafen (DE); Matthias Fies, Landau (DE); Wolfgang Staffel, Otterstadt (DE)

(73) Assignee: BASF SE, Ludwigshafen (DE)

(21) Appl. No.: 13/640,174

(22) PCT Filed: Apr. 9, 2010
(86) PCT No.: PCT/EP10/54691

§ 371 Date: Oct. 9, 2012

(51) Int. Cl. C09D 11/10; B05D 3/00

(52) U.S. Cl. 427/256; 106/31.13; 522/11; 560/201

(57) ABSTRACT

Printing ink comprising a divinyl ester of a C2 to C8 dicarboxylic acid.

The invention relates to a printing ink which comprises a divinyl ester of a C2 to C8 dicarboxylic acid.

Printing inks are advantageously often solvent-free. Consequently, there is no necessity to remove solvent after the printing process. Even without solvent, the printing ink should be fluid at room temperature. For this purpose, printing inks frequently comprise so-called reactive diluents; these are low molecular weight compounds which become part of the resulting coating after curing. The choice of reactive diluents also affects the performance characteristics of the coating obtained.

WO 2008/055954 discloses radiation-curable coating materials which comprise divinyl adipate as a reactive diluent. The low viscosity of the coating material to be obtained is advantageous. Furthermore, U.S. Pat. No. 5,254,603 describes coating materials which comprise vinyl adipate. EP-A-552795 relates to UV-curable coating materials which comprise a divinyl ester and have good adhesion.

Printing inks are not mentioned in the above documents. In the case of printing inks, it is particularly important that the adhesion to very different materials to be printed on is good. What is particularly critical here is the adhesion to nonpolar substrates, e.g. having plastic surfaces.

An object of the present invention was therefore printing inks which have a low viscosity and can therefore be processed in solvent-free form and have performance characteristics which are as good as possible, in particular good adhesion to nonpolar substrates being important.

Accordingly, the printing inks defined at the outset were found.

The printing inks according to the invention comprises a divinyl ester of a C2 to C8 dicarboxylic acid. This is preferably divinyl adipate.

Preferred printing inks comprise from 0.5 to 50% by weight, preferably 5 to 50% by weight and particularly preferably from 10 to 40% by weight of the divinyl ester of a C2 to C8 dicarboxylic acid.

In addition to the divinyl ester of a C2 to C8 dicarboxylic acid, the printing ink may comprise further constituents.

Further monomers, oligomers and polymers are suitable as further constituents which form the polymer film after curing. The divinyl esters and any further monomers, oligomers and polymers are also designated as a whole as binders.

### Further Monomers

Further monomers (compounds having a copolymerizable, ethylenically unsaturated group) preferably have a molecular weight of less than 300, in particular less than 200, g/mol. They serve in particular as reactive diluents. Possible monomers are, for example selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl ethers of alcohols comprising 1 to 10 carbon atoms.

Vinyl esters of carboxylic acids having 1 to 20 carbon atoms are, for example, vinyl laureate, vinyl stearate, vinyl propionate, vinyl versatate and vinyl acetate.

Suitable vinylaromatic compounds are vinyltoluene, a- and p-methylstyrene, a-butylstyrene, 4-n-butylstyrene, 4-n-decylstyrene and preferably styrene. Examples of nitriles are acrylonitrile and methacrylonitrile.

For example, vinyl methyl ether or vinyl isobutyl ether may be mentioned as vinyl ethers. Vinyl ethers of alcohols comprising 1 to 4 carbon atoms are preferred.

In particular the C1- to C10-alkyl acrylates and C1- to C10-alkyl methacrylates, particularly preferably C1- to C8-alkyl acrylates and C1- to C8-alkyl methacrylates, are suitable as alkyl (meth)acylates.

Methyl acrylate, ethyl acrylate, n-butyl acrylate, n-hexyl acrylate, octyl acrylate and 2-ethylhexyl acrylate and mixtures of these monomers are very particularly preferred.

In particular, mixtures of the (meth)acrylic acid esters are also suitable.

Furthermore, polar monomers having isocyanate, amino, amido, epoxy, hydroxyl or acid groups are also suitable.

For example, monomers having carboxyl, sulfo or phosphonic acid groups (e.g. vinylphosphonic acid) may be mentioned. Carboxyl groups are preferred. For example, acrylic acid, methacrylic acid, itaconic acid, maleic acid or fumaric acid or acryloyloxypropionic acid may be mentioned.

Further monomers are, for example, also monomers comprising hydroxyl groups, in particular C1-C10-hydroxyalkyl (meth)acrylates, (meth)acrylamide and monomers comprising ureido groups, such as ureido (meth)acrylates.

Mono(meth)acrylates of dihydric or polyhydric alcohols, e.g. monoacrylates or monomethacrylates of ethylene glycol or propylene glycol, may also be mentioned as further monomers.

Reaction products of (meth)acrylic acid and monoepoxides, e.g. phenyl glycidyl ether or glycidyl versatate, are also suitable.

Phenyloxyethylglycol mono(meth)acrylate, glycidyl acrylate, glycidyl methacrylate, amino (meth)acrylates, such as 2-aminoethyl (meth)acrylate, or may also be mentioned as further monomers.

N-vinylpyrrolidone, N-vinylcaprolactam and N-vinylformamide are also particularly suitable.

### Oligomers

In particular, compounds having at least two ethylenically unsaturated groups capable of free radical or ionic polymerization (polymerizable group for short) are suitable. Compounds having on average from 1.5 to 6, in particular from 2 to 4, polymerizable groups are preferred. The above polymerizable group may be, for example, an N-vinyl, vinyl ether or vinyl ester group; it is in particular an acryloyl or methacryloyl group ((meth)acryloyl groups for short).

The weight average molecular weight Mw of the oligomers is preferably less than 5000, particularly preferably less than 3000, g/mol (determined by gel permeation chromatography using polystyrene as a standard and tetrahydrofuran as an eluent).

The oligomers are in particular (meth)acryloyl compounds.

They may be, for example, (meth)acrylates, i.e. esters of acrylic acid or methacrylic acid.

(Meth)acrylates and in particular acrylates of polyfunctional alcohols, in particular those which, apart from the hydroxyl groups, comprise no further functional groups or at any rate ether groups, may be mentioned as (meth)acrylates. Examples of such alcohols are bifunctional alcohols, such as ethylene glycol, propylene glycol and representatives thereof having a higher degree of condensation, for example, such as, diethylene glycol, triethylene glycol, dipropylene glycol, tripropylene glycol, etc., butanediol, pentanediol, hexanediol, neopentyl glycol, alkoxylated phenolic compounds, such as ethoxylated or propoxylated bisphenols, cyclohexanedimethanol, trifunctional and higher-functional alcohols, such as glycerol, trimethylolpropane, butanetriol, trimethylolethane, pentaerythritol, ditrimethylolpropane, dipentaerythritol, sorbitol, mannitol and the corresponding alkoxylated, in particular ethoxylated and propoxylated, alcohols.

The alkoxylation products are obtainable in a known manner by reacting the above alcohols with alkylene oxides, in particular ethylene oxide or propylene oxide. The degree of alkoxylation to the hydroxyl group is preferably from 0 to 10, i.e. 1 mol of hydroxyl group can preferably be alkoxylated with up to 10 mol of alkylene oxides.

Polyester (meth)acrylates may furthermore be mentioned as (meth)acrylate compounds, these being the (meth)acrylates of polyesterols.

Suitable polyesterols are, for example, those which can be prepared by esterification of polycarboxylic acids, preferably dicarboxylic acids, with polyols, preferably diols. The starting materials for such polyesters containing hydroxyl groups are known to the person skilled in the art. Preferably used dicarboxylic acids are succinic acid, glutaric acid, adipic acid, sebacic acid, o-phthalic acid, the isomers and hydrogenation products thereof and esterifiable derivatives, such as anhydrides or dialkyl esters of said acids. Maleic acid, fumaric acid, tetrahydrophthalic acid or the anhydrides thereof are also suitable. Suitable polyols are the above mentioned alcohols, preferably ethylene glycol, 1,2- and 1,3-propylene glycol, butane-1,4-diol, hexane-1,6-diol, neopentyl glycol, cyclohexanedimethanol and polyglycols of the ethylene glycol and propylene glycol type.

Polyester (meth)acrylates can be prepared in a plurality of stages or in one stage, as described, for example, in EP 279 303, from acrylic acid, polycarboxylic acid and polyol.

For example, epoxide (meth)acrylates or urethane (meth)acrylates may also be employed.

Epoxide (meth)acrylates are, for example, those which are obtainable by reacting epoxidized olefins or poly- or mono- or diglycidyl ethers, such as bisphenol A diglycidyl ether, with (meth)acrylic acid.

The reaction is known to the person skilled in the art and is described, for example, in R. Holmann, U.V. and E.B. Curing Formulation for Printing Inks and Paints, London 1984.

Urethane (meth)acrylates are in particular reaction products of hydroxyalkyl (meth)acrylates with poly- or diisocyanates (cf. also R. Holmann, U.V. and E.B. Curing Formulation for Printing Inks and Paints, London 1984).

The above (meth)acrylate compounds can in each case also comprise functional groups, for example hydroxyl groups, which are not esterified with (meth)acrylic acid.

Further oligomers are, for example, low molecular weight unsaturated polyesters which in particular have double bonds as a result of a content of maleic acid or fumaric acid and are copolymerizable.

Preferred oligomers are fluid at 20° C., 1 bar.

In a preferred embodiment, the coating material comprises (meth)acryloyl compounds, in particular (meth)acrylates of polyfunctional alcohols, in particular those which, apart from the hydroxyl groups, comprise no further functional groups or at any rate ether groups, in particular (meth)acryloyl compounds which are fluid at 20° C., 1 bar, and have from 2 to 4 (meth)acryloyl groups.

### Polymers

Suitable polymers may have reactive groups, for example polymerizable groups or functional groups, so that bonding to the above monomers or oligomers takes place during the curing. Also suitable, however, are polymers without such groups, which subsequently form an independent continuous phase or an interpenetrating network in the coating obtained.

Suitable polymers are, for example, polyesters, polyadducts, in particular polyurethanes, or polymers obtainable by free radical polymerization. Polymers obtainable by free radical polymerization are particularly suitable, preferably those which comprise to polymer at least 40% by weight, particularly preferably at least 60% by weight, very particularly preferably at least 80% by weight, of so-called main monomers.

The main monomers are selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising from 1 to 10 carbon atoms, aliphatic hydrocarbons having from 2 to 8 carbon atoms and 1 or 2 double bonds or mixtures of these monomers. Examples of preferred monomers are mentioned above.

The printing ink preferably comprises further constituents of the binder, selected from compounds having a polymerizable, ethylenically unsaturated group (monomers), compounds differing from the divinyl esters and having at least two polymerizable, ethylenically unsaturated groups (oligomers) or polymers.

In addition to the divinyl ester of a C2 to C8 dicarboxylic acid, particularly suitable printing inks also comprise (meth)acryloyl compounds, in particular (meth)acrylates of polyfunctional alcohols, in particular those which, apart from the hydroxyl groups, comprise no further functional groups or at any rate ether groups. The content of such (meth)acryloyl compounds is preferably from 5 to 90% by weight, in particular from 15 to 80% by weight, based on the printing ink.

In addition to the polymerizable constituents, the printing inks may comprise further constituents. Pigments, including effect pigments, dyes, stabilizers, e.g. UV absorbers, antioxidants or biocides, leveling agents, antistatic agents, etc., are particularly suitable.

The printing inks may comprise water or organic solvents. Preferred printing inks comprise little or no water or organic solvent (unreactive compound fluid at 20° C., 1 bar).

In a preferred embodiment, the printing ink comprises less than 20% by weight of water or organic solvents, particularly preferably less than 10 parts by weight and in particular less than 5 parts by weight of water or organic solvents, based on 100 parts by weight of printing ink. Very particularly preferably, the printing ink comprises substantially no water or other organic solvents.

In a preferred embodiment, the printing ink is radiation-curable. The curing can then be effected with high-energy electromagnetic radiation, in particular with UV light or electron beams.

Preferably, the printing ink comprises at least one photoinitiator for this purpose.

The photoinitiator may be, for example, so-called a-cleavers, i.e. photoinitiators in which a chemical bond is cleaved so that 2 free radicals form, which initiate the further crosslinking or polymerization reactions.

For example, acylphosphine oxides (Lucirin® brands from BASF), hydroxyalkyl-phenones (e.g. Irgacure® 184), benzoin derivatives, benzil derivatives, dialkyloxyacetophenones may be mentioned.

In particular, they may be so-called H-abstractors which remove a hydrogen atom from the polymer chain; for example, these are photoinitiators having a carbonyl group. This carbonyl group shifts into a C—H bond with formation of a C—C—O—H group.

In particular, acetophenone, benzophenone and derivatives thereof may be mentioned here.

Benzoins or benzoin ethers may also be mentioned.

Photoinitiators can be used alone or as a mixture, mixtures of photoninitiators having different modes of action may also be particularly suitable.

Photoninitiators can also be bound to an above polymer or oligomer, if present.

In the case of thermal curing or a combination of radiation curing and thermal curing, one or more thermally activatable initiators, such as peroxides, azo compounds, etc., may be added.

The printing ink generally comprises at least one dye or pigment as a further constituent.

### Regarding the Use

The printing inks according to the invention are suitable for printing of different substrates, for example having surfaces comprising plastic, metal, or wood, or for paper.

For this purpose, the printing ink can be applied to the substrates by known printing processes and then cured, the curing preferably being effected by high-energy electromagnetic radiation (radiation curing).

The printing ink is particularly suitable as radiation-curable printing ink. The printing ink is particularly preferably used by the screen printing process or inkjet printing process.

The printing inks according to the invention have good performance characteristics, for example good adhesion, in particular good adhesion to polymer films.

The mixture used as reactive diluent is liquid and can therefore be easily handled; the advantageous performance characteristics are substantially due to N-vinylpiperidone or in particular to the mixture of N-vinylpiperidone with the solid monomer, preferably N-vinylcaprolactam.

### EXAMPLES

Divinyl adipate (abbreviated to DA) was used as reactive diluent in printing inks curable by high-energy radiation.

For this purpose, a pigment paste was prepared from oligomers containing acrylate groups, dispersant and pigment and was then diluted by addition of the DA. The printing inks were applied to the substrate (KD paper) by means of a bar applicator and exposed to an energy of 120 W/m on a UV exposure unit equipped with a high pressure UV mercury lamp (coat thickness 6 μm).

For comparison, printing inks were prepared with N-vinyl-pyrrolidone (NVP) and divinyl 1,4-cyclohexanedicarboxylate (CHD).

### Adhesion

For the investigation of the adhesion of the exposed coatings, a “Crystal” Scotch adhesive tape was used. The adhesive tape was stuck to the exposed coating and peeled off again and it was determined whether the coating had become detached therewith.

Rating 0 (no delamination)-5 (complete delamination)

TABLE 1
Constituents of the printing inks and results

| Example | C1 | 1 | C2 | C3 | 2 | C4 |
|---|---|---|---|---|---|---|
| Laromer ® LR 8986 | 36 | 36 | 36 | | | |
| (Epoxy acrylate) | | | | | | |
| [parts by weight] | | | | | | |
| Laromer LR 8987 | | | | 36 | 36 | 36 |
| (Urethane acrylate from BASF) | | | | | | |
| [parts by weight] | | | | | | |
| Laromer LR 9013 | 9 | 9 | 9 | 9 | 9 | 9 |
| [parts by weight] | | | | | | |
| Pigment Hostaperm Pink | 5 | 5 | 5 | 5 | 5 | 5 |
| [parts by weight] | | | | | | |
| Lucirin ® TPO | 1 | 1 | 1 | 1 | 1 | 1 |
| [parts by weight] | | | | | | |
| (Photoinitiator) | | | | | | |
| Darocur ® 1173 | 4 | 4 | 4 | 4 | 4 | 4 |
| [parts by weight] | | | | | | |
| (Photoinitiator) | | | | | | |
| Laromer ® LR 8956 | 5 | 5 | 5 | 5 | 5 | 5 |
| [parts by weight] | | | | | | |
| NVP | 40 | | | 40 | | |
| DA | | 40 | | | 40 | |
| CHD | | | 40 | | | 40 |
| Viscosity I.C.I at 23° C., | 0.32 | 0.32 | 0.31 | 0.38 | 0.3 | 0.3 |
| 1/20 s [Pas] | | | | | | |
| Belt speed [m/min] required for | 2 × 15 | 3 × 15 | 3 × 15 | 3 × 15 | 5 × 15 | 5 × 15 |
| curing and number of passes | | | | | | |
| as a measure of the reactivity | | | | | | |
| Adhesion to | | | | | | |
| immediately | | | | | | |
| Polypropylene, transparent | 5 | 5 | 5 | 5 | 5 | 5 |
| Polyethylene terephthalate | 4 | 1 | 1 | 5 | 1 | 1 |
| (PET X13 Melinax) | | | | | | |
| Polyvinyl chloride | 1 | 1 | 1 | 1 | 3 | 3 |
| (PVC TF M120) | | | | | | |
| After 14 days | | | | | | |
| Polypropylene, transparent | 4 | 1 | 2 | 4 | 1 | 1 |
| Polyethylene terephthalate | 2 | 1 | 1 | 3 | 1 | 1 |
| (PET X13 Melinax) | | | | | | |
| Polyvinyl chloride | 1 | 1 | 3 | 1 | 1 | 1 |
| (PVC TF M120) | | | | | | |

The above Laromers are radiation-curable methacryloyl compounds from BASF.

1. A printing ink, comprising:
a divinyl ester of a C2 to C8 dicarboxylic acid.

2. The printing ink of claim 1, wherein the divinyl ester is divinyl adipate.

3. The printing ink of claim 1, wherein the printing ink comprises at least 0.5% by weight of the divinyl ester, based on a total weight printing ink.

4. The printing ink of claim 1, wherein the printing ink comprises from 0.5 to 50% by weight of the divinyl ester, based on a total weight of the printing ink.

5. The printing ink of claim 1, which is a radiation-curable printing ink.

6. The printing ink of claim 5, further comprising:
a binder constituent selected from the group consisting of a compound comprising a polymerizable, ethylenically unsaturated group (monomers), a compound differing from the divinyl esters and comprising at least two polymerizable, ethylenically unsaturated groups (oligomers), and polymers.

7. The printing ink of claim 1, comprising less than 5% by weight of water or an organic solvent.

8. The printing ink of claim 1, further comprising:
a photoinitiator.

9. A process for printing on a substrate, the process comprising:
contacting the printing ink of claim 1 with a substrate.

10. The process of claim 9, wherein the contacting comprises a printing process selected from the group consisting of inkjet printing, screen printing, flexographic printing, letter press printing, gravure printing and offset printing.

11. A process for producing an imprinted substrate, the process comprising:
applying a printing ink of claim 1 to a substrate; and then,
curing the printing ink.

12. The printing ink of claim 2, wherein the printing ink comprises from 5 to 50% by weight of the divinyl ester, based on a total weight of the printing ink.

13. The printing ink of claim 2, wherein the printing ink comprises from 10 to 40% by weight of the divinyl ester, based on a total weight of the printing ink.

14. The printing ink of claim 12, comprising less than 5% by weight of water or an organic solvent.

15. The printing ink of claim 13, comprising less than 5% by weight of water or an organic solvent.

16. The printing ink of claim 14, further comprising:
a photoinitiator.

17. The printing ink of claim 15, further comprising:
a photoinitiator.
